(19) United States
(12) Patent Application Publication
(10) Pub. No.: US 2022/0058316 A1
(43) Pub. Date: Feb. 24, 2022

(54) METHOD FOR CLASSIFICATION PARTS, SYSTEM OF PROCESSING, AND ELECTRONIC DEVICE

(71) Applicant: HONGFUJIN PRECISION ELECTRONICS(TIANJIN)CO.,LTD., Tianjin (CN)

(72) Inventors: CHIAO-LING LIN, New Taipei (TW); HSUEH-FANG AI, New Taipei (TW)

(21) Appl. No.: 17/097,268

(22) Filed: Nov. 13, 2020

(30) Foreign Application Priority Data
Aug. 18, 2020 (CN) 202010833365.8

(51) Int. Cl. G06F 30/27; G06K 9/62; G06N 20/00

(52) U.S. Cl. CPC G06F 30/27; G06K 9/6277; G06F 2111/20; G06K 9/6256; G06N 20/00; G06K 9/622

(57) ABSTRACT

A method for classification parts and components of a manufacturable device and a system of processing data relevant to such parts obtains data of the components, the components comprising many different types of parts to be assembled together. A clustering model can cluster the data to each cluster and the labeling module would label for the data in each cluster. A classification model classifies and assembles data into data classes that are labeled, also indicating assembly of the different types of components. The disclosure also provides an electronic device and a non-transitory storage medium.

### FIELD

The subject matter herein generally relates to the manufacture of electronic and other devices and a storage medium. classification

### BACKGROUND

A complete and finished product is usually composed of many parts. The product comprises many separately-manufactured parts, and different stages of the product or part-product are reached, then the results of the stages are combined into the complete finished product. After each stage, the semi-finished product is not screened in relation to size, and part-products are directly assembled into a finished product, even though misalignments due to size differences may have arisen during assembly, this will also affect product quality.

Therefore, an improvement is desired.

### BRIEF DESCRIPTION OF THE DRAWINGS

Implementations of the present disclosure will now be described, by way of embodiments, with reference to the attached figures.

FIG. 1 is a block diagram of an embodiment of an electronic device of the present disclosure.

FIG. 2 is a flowchart of an embodiment of a method of processing.

FIG. 3 is a flowchart of another embodiment of a method.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

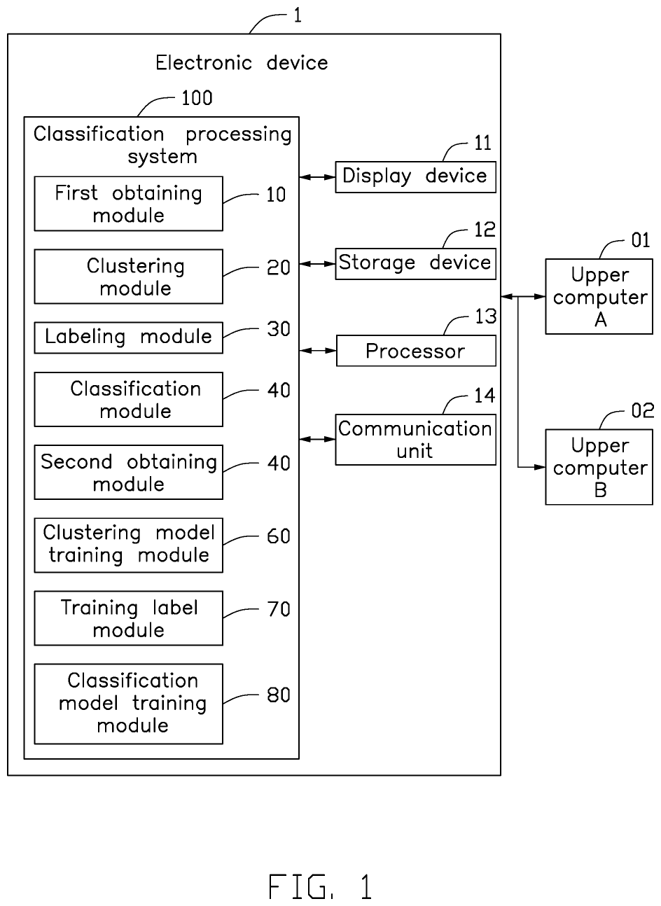

FIG. 1 illustrates a classification processing system 100 in accordance with an embodiment of the present disclosure.

The classification processing system 100 includes a first obtaining module 10, a clustering module 20, a labeling module 30, a classification module 40, a second obtaining module 50, a clustering model training module 60, a training label module 70, and a classification model training module 80.

In the embodiment, the classification processing system 100 can be applied to an electronic device 1. In one embodiment, the electronic device 1 can be a computer.

The electronic device 1 also includes, but is not limited to, a display device 11, a storage device 12, a processor 13, and a communication unit 14. The electronic device 1 communicates with an upper computer through the communication unit 14 that supplies components. For example, the electronic device 1 can communicate with an upper computer A01 of a component A or an upper computer B02 of a component B through the communication unit 14.

In the embodiment, the classification processing system 100 classifies each stage-finished product before assembling the product or part-product into a finished product, and whether the assembled stage-finished product or part-product is compatible with others, and whether the assembled product is a qualified product.

In one embodiment, the classification processing system 100 trains a model through the second obtaining module 50, the clustering model training module 60, the training label module 70, and the classification model training module 80, the trained model processes data of the components to be assembled together.

The second obtaining module 50 is used to acquire training data of the different types of assemble components.

The components are different types of components that are to be assembled into a finished product. The components are to be assembled into a complete finished product or into a part-product. The components can be two or more types of components.

In a process of acquiring data, a threshold is defined as the initial minimum number of items of data that should be accumulated. According to the threshold, the acquired data will be divided into training data and test data for modeling and testing. Until the total number of items reaches the threshold it is training data, when it equals or exceeds the threshold, it becomes test data.

In the embodiment, the clustering model training module 60 creates clusters of the training data by using the clustering model to obtain each training cluster, and adjusts the clustering model to a preset balance of parameters, to obtain the clustering model. The preset balance of parameters is used to balance the amount of data in each training cluster.

In the embodiment, the clustering model training module 60 creates clusters of the data of different types of components to obtain the training clusters, and the training clusters are created according to the similarity of the data, thereby completing the preliminary division. To obtain a clustering model, the model is trained according to the preset balance of parameters and the training clusters to obtain a clustering model. A difference in ratio between the training clusters should not be less than the preset balance of parameters, to avoid imbalances in the number of training clusters after the clustering of different production lines in the system 100.

The process of dividing a collection of physical objects or abstract conceptions into multiple classes composed of similar objects or conceptions is called clustering. Each cluster generated by the clustering is a collection of data as to objects which are similar to objects in the same cluster and different from the objects in other clusters, and different types of components are thereby divided in a preliminary fashion.

For each item of data in the training cluster, the distance to the cluster center of each training cluster is calculated by metric, such as the Euclidean distance, the Chebyshev distance, etc., and adjust this distance to make it closer to the center of other training clusters and away from the original data with a farther center redefining the result of clustering so that the number difference between each training cluster is less than the preset balance of parameters.

The training label module 70 sets labels on the training data of each training cluster to obtain labeled training data.

In the embodiment, for each training cluster, the training data is compared with data as to the standard size of a product produced by the production line corresponding to the training data, and the corresponding label is set according to the comparison result. The labels of all training data in each training cluster are ordered labels.

The classification model training module 80 classifies the labeled training data by training a classification model to obtain a training classification result, and adjusts the classification model according to preset classification parameter and the training classification result, to obtain a classification model, and the preset classification parameter makes the classification of the different types of assemble components uniform and consistent.

In the embodiment, the classification training model finds a hyperplane for segmenting the labeled data and finds parameters to maximize the distance of each class after classification. Adjustment of the hyperplane to change the weight through the preset balance parameter to deal with the problem of balance of the number of classes, and the number of classification results of assemble components is correspondingly consistent.

The first obtaining module 10 is used to acquire data of the components to be assembled, and the components to be assembled can include different types of components that are to be assembled with each other.

In one embodiment, the electronic device 1 communicates with the upper computer A01, the upper computer B02 of different production lines through the communication unit 14, and the system 100 obtains data of each semi-finished or part-product to be assembled into a finished or semi-finished product.

In the embodiment, the components to be assembled are many different types of components that are to be assembled into a finished product.

The clustering module 20 is configured for clustering the data to obtain each cluster.

In the embodiment, the clustering module 20 uses the trained clustering model to cluster the obtained different types of component data to obtain each cluster, and complete a preliminary division.

The labeling module 30 is used to set labels on the data in each cluster to obtain data with labels.

The classification module 40 is configured to use a classification model to classify the labeled data, to obtain classification results which indicate the assembly of different types of components.

In some embodiments, the storage device 12 is used to store program code and various data. In one embodiment, the storage device 12 may include random access memory, as well as non-volatile memory, such as hard drives, memory, plug-in hard drives, smart media card, secure digital, SD card, Flash Card, at least one disk memory, flash device. The storage device 12 can perform data communication with the processor 13 through the communication unit 14.

In at least one embodiment, the processor 13 is a central processing unit (CPU), another general-purpose processor, a digital signal processor (DSPs), an application specific integrated circuit (ASIC), a Field-Programmable Gate Array (FPGA), another programmable logic device, a discrete gate, a transistor logic device, or a discrete hardware component, etc. The processor 13 may be a microprocessor, or the processor 13 may be any conventional processor.

The processor 13 can call up the program code stored in the storage device 12 to perform functions. For example, the various functional modules described in FIG. 1 are program codes stored in the storage device 12 and executed by the processor 13 to implement a pre-assembly classification processing method.

The functional module referred to in the present application refers to a series of program instruction segments that can be executed by the processor 13 of the electronic device 1 and can complete fixed functions, and are stored in the storage device 12 of the electronic device 1.

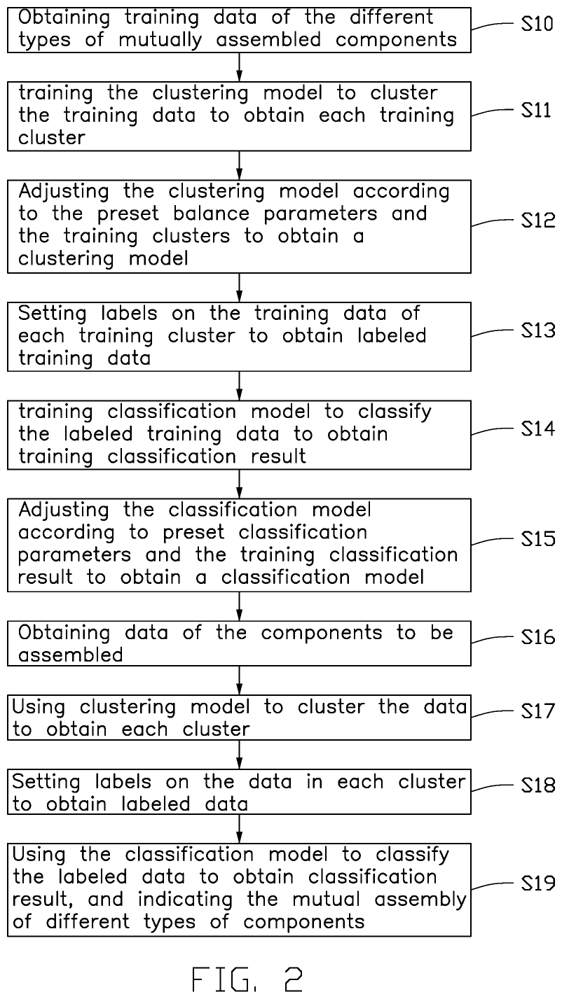

The functional modules are shown in the flowchart in FIG. 2.

FIG. 2 illustrates a flowchart of a classification processing method, the method may include the following steps.

In block S10, obtaining training data of the different types of mutually assembled components.

In the embodiment, different types of components to be assembled produced by different production lines, and these components to be assembled are assembled with each other to obtain a finished or semi-finished product.

In the embodiment, corresponding data can be obtained by continuously obtaining machine parameters applicable to machines in different production lines, or measurement data in front of assembly stations. For example: when etching an ink flow channel, data as to the size of the flow channel can be estimated according to the etching time, the amount of etching liquid, and other variables.

In the process of acquiring data, the initial minimum number of items of data that need to be accumulated is defined as a first threshold. With the first threshold as a criterion, the acquired data is divided into training data and test data for modeling and testing. That is, when the total amount of data is less than the first threshold, it is training data, and the training data is used to train the model. When the first threshold is equaled or exceeded, it is test data, and the test data is used for testing.

In block S11, training the clustering model to cluster the training data to obtain each training cluster.

In block S12, adjusting the clustering model according to the preset balance parameters and the training clusters to obtain a clustering model, and the preset balance parameters are used to balance the amount of data in the training clusters.

In the embodiment, the clustering model may be K-MEANS clustering algorithm, mean shift clustering algorithm, DBSCAN (Density-Based Spatial Clustering of Applications with Noise) clustering algorithm.

In the embodiment, the preset balance parameter is a preset parameter. When the clustering model performs clustering, each training cluster is obtained according to the similarity of the data, and the proportional difference between the number of each training cluster is adjusted through the preset balance parameter, to avoid imbalance in the number of clusters of components produced by different production lines.

In the embodiment, for each data in the training cluster, calculate the distance metric to the cluster center of each training cluster, such as Euclidean distance, Chebyshev distance, use this distance to adjust, make it closer to the center of other clusters, and away from the original center, the farther data redefines its clustering results, so that the number difference between each training cluster is less than the preset balance parameter.

In block S13, setting labels on the training data of each training cluster to obtain labeled training data.

In the embodiment, for each training cluster, the training data in it is compared with the standard product size data produced by the production line corresponding to the data, and the corresponding label is set according to the comparison result. The labels of all training data in each training cluster are ordered labels.

In block S14, training a classification model to classify the labeled training data to obtain a training classification result.

In block S15, adjusting the classification model according to preset classification parameters and the training classification result to obtain a classification model. In the embodiment, the preset classification parameter allows the classification result of the different types of mutually assembled components to be consistent.

In the embodiment, the classification model finds a hyperplane to make it segment the labeled data and finds parameters to maximize the distance of each class after classification. The hyperplane is adjusted to change the weight through the preset balance parameters to deal with the problem of the balance of the number of classes, so that the number of classification results of mutually assembled components is correspondingly consistent.

In block S16, obtaining data of the components to be assembled.

The components to be assembled can include different types of components that are assembled with each other.

The data of the components to be assembled can be obtained in the following ways: load production data of a machine that produces the components to be assembled, so as to obtain dimensional data of the components to be assembled according to the production data.

In block S17, using the clustering model to cluster the data to obtain each cluster.

In the embodiment, the obtained data includes different types of components data produced by different production lines. The obtained component data is clustered through a clustering model, and each cluster is divided according to the data similarity. When the data differs greatly, the clusters corresponding to different types of components can be obtained.

In the embodiment, the clustering model is obtained after training through block S11 and block S12. After the clustering model divides the data, the amount of data in each cluster obtained is balanced.

In block S18, setting labels on the data in each cluster to obtain labeled data.

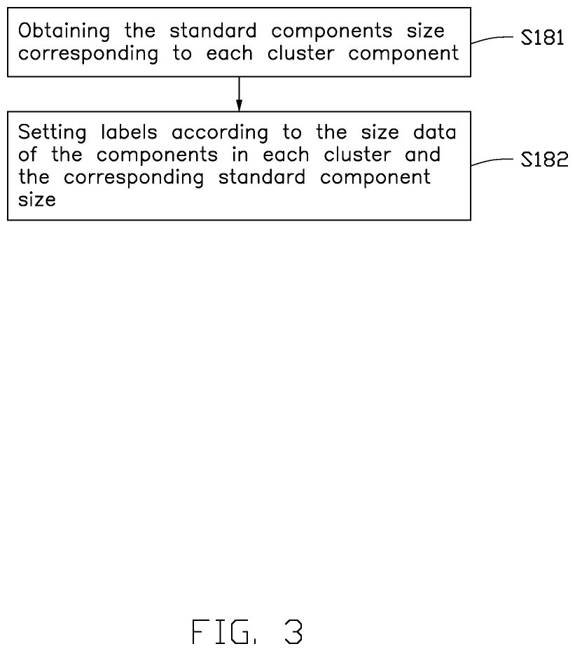

Referring to FIG. 3, the setting labels on the data in each cluster to obtain labeled data may be by the following steps:

In block S181, obtaining the standard components size corresponding to each cluster component.

In the embodiment, the components produced by different production lines have their corresponding standard component sizes. After each cluster is obtained in block S17, the component produced by different production lines are divided accordingly

In block S182, setting labels according to the size data of the components in each cluster and the corresponding standard component size.

In the embodiment, for each cluster, the training data in the cluster is compared with the standard product size data produced by the production line corresponding to the data, and the corresponding label is set according to the comparison result. The labels of all training data in each cluster are ordered labels.

In block S19, using the classification model to classify the labeled data to obtain classification results, and indicating the mutual assembly of different types of components.

In the embodiment, the classification model is obtained after training through block S14 and block S15, and the labeled data is classified through the classification model, and the classification of components produced by different production lines is based on the preset parameters are consistent, and then according to the classification result, different types of components are instructed to assemble each other.

For example, three different production lines produce three different types of components, namely component A, component B and component C. Two components A, one component B and one component C can be assembled into a finished product. The dimensions of the components are in line with the standard, but there are still small differences.

To improve quality, the components are divided into several groups and assembled. Cluster the part data composed of component A, component B, and component C. If the components are divided into three sizes, construct 3 clusters to obtain cluster A, cluster B, and cluster C. Compare the data of cluster A, cluster B, and cluster C according to the standard product size data corresponding to the production line that produces each part. Sort the component size data of cluster A, cluster B, and cluster C from small to large, making three clusters Respectively can be redefined as the part label of small size data, the part label of medium size data, and the part label of large size data.

The classification model classifies the labeled data in cluster A, cluster B, and cluster C, and the classification results of component A, component B, and component C are consistent. Component A, component B, and component C are all divided into 3 classes, including larger than standard product size data, less than standard product size data, and equal to less than standard product size data.

The quantity of each class of component A is twice that of component B and component C. The component A, the component B, and the component C that are larger than the standard product size data can be assembled together. The component A and parts that are smaller than the standard product size data assemble component B and the component C together. The classification model can assemble component A, component B and component C that are equal to the standard product size data. The classification model can instruct to assign the component A, the component B and the component C with label 1 together, and instruct to assign the component A with label 2, the component B and the component C are assigned together.

The invention also provides a non-transitory storage medium. Computer instructions are stored on the non-transitory storage medium. The computer instructions may be stored in the storage device 12 or the processor 13, and when executed by one or more processors 13, and the processor is used to implement the classification processing method as described in the above method embodiment.

When the modules/units integrated into the classification processing system first obtaining module 100 are implemented in the form of software functional units of independent or standalone products, they can be stored in a non-transitory readable storage medium. Based on this understanding, all or part of the processes in the methods of the above embodiments implemented by the present disclosure can also be completed by related hardware instructed by computer-readable instructions. The computer-readable instructions can be stored in a non-transitory readable storage medium. The computer-readable instructions, when executed by the processor, may implement the steps of the embodiments of the foregoing method or methods. The computer-readable instructions include computer-readable instruction codes, and the computer-readable instruction codes can be in a source code form, an object code form, an executable file, or some intermediate form. The non-transitory readable storage medium can include any entity or device capable of carrying the computer-readable instruction code, a recording medium, a U disk, a mobile hard disk, a magnetic disk, an optical disk, a computer memory, or a read-only memory (ROM).

The division of modules described above is a logical function division, the actual implementation of division can be in some other way. In addition, each function module in each embodiment of this application may be integrated into the same processing unit, or the individual modules may be physically present, or two or more modules may be integrated into the same cell.

The above-integrated module can be implemented in the form of hardware, or in the form of hardware plus software function module.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the exemplary embodiments described above may be modified within the scope of the claims.

What is claimed is:

1. A classification processing method comprising:
obtaining data of components to be assembled; wherein the components to be assembled comprises different types of the components that are assembled with each other;
using a clustering model to cluster the data to obtain each cluster;
setting labels on the data in each cluster to obtain labeled data;
using a classification model to classify the labeled data to obtain classification results, and indicating mutual assembly of different types of the components.

2. The classification processing method according to claim 1, further comprising:
obtaining training data of the different types of the mutually assembled components;
training the clustering model to cluster the training data to obtain each training cluster;
adjusting the clustering model according to the preset balance parameters and the training clusters to obtain a clustering model, and the preset balance parameters are used to balance the amount of data in the training clusters.

3. The classification processing method according to claim 2, further comprising:
setting labels on the training data of each training cluster to obtain labeled training data;
training the classification model to classify the labeled training data to obtain the training classification result;
adjusting the classification model according to preset classification parameters and the training classification result to obtain a classification model; wherein the preset classification parameter makes the classification result of the different types of mutually assembled components consistent.

4. The classification processing method according to claim 1, further comprising:
loading production data of a machine that produces the components to be assembled, to obtain dimensional data of the components to be assembled according to the production data;
obtaining size data of the components to be assembled by measuring the size of the components to be assembled.

5. The performance tuning method according to claim 4, further comprising:
obtaining standard components size corresponding to each cluster component;
setting labels according to the size data of the components in each cluster and the corresponding standard component size.

6. An electronic device comprising:
a storage device; and
a processor;
wherein the storage device stores one or more programs, which when executed by the processor, cause the processor to:
obtain data of components to be assembled; wherein the components to be assembled comprises different types of the components that are assembled with each other;
use a clustering model to cluster the data to obtain each cluster;
set labels on the data in each cluster to obtain labeled data
use a classification model to classify the labeled data to obtain classification results, and indicating mutual assembly of different types of the components.

7. The electronic device according to claim 6, wherein the processor is further caused to:
obtain training data of the different types of the mutually assembled components;
train the clustering model to cluster the training data to obtain each training cluster;
adjust the clustering model according to the preset balance parameters and the training clusters to obtain a clustering model, and the preset balance parameters are used to balance the amount of data in the training clusters.

8. The electronic device according to claim 7, wherein the processor is further caused to:
set labels on the training data of each training cluster to obtain labeled training data;
train a classification model to classify the labeled training data to obtain the training classification result;
adjust the classification model according to preset classification parameters and the training classification result to obtain a classification model; wherein the preset classification parameter makes the classification result of the different types of mutually assembled components consistent.

9. The electronic device according to claim 8, wherein the processor is further caused to:
load production data of a machine that produces the components to be assembled, to obtain dimensional data of the components to be assembled according to the production data;
obtain size data of the components to be assembled by measuring the size of the components to be assembled.

10. The electronic device according to claim 9, further causing the at least one processor to:
obtain standard components size corresponding to each cluster component;
set labels according to the size data of the components in each cluster and the corresponding standard component size.

11. A non-transitory storage medium having stored thereon instructions that, when executed by a processor of an electronic device, causes the processor to perform a performance tuning method, the method comprising:
obtaining data of components to be assembled; wherein the components to be assembled comprises different types of the components that are assembled with each other;
using a clustering model to cluster the data to obtain each cluster;
setting labels on the data in each cluster to obtain labeled data;
using a classification model to classify the labeled data to obtain classification results, and indicating mutual assembly of different types of the components.

12. The non-transitory storage medium according to claim 11, further comprising:
obtaining training data of the different types of the mutually assembled components;
training the clustering model to cluster the training data to obtain each training cluster;
adjusting the clustering model according to the preset balance parameters and the training clusters to obtain a clustering model, and the preset balance parameters are used to balance the amount of data in the training clusters.

13. The non-transitory storage medium according to claim 12,
setting labels on the training data of each training cluster to obtain labeled training data;
training the classification model to classify the labeled training data to obtain the training classification result;
adjusting the classification model according to preset classification parameters and the training classification result to obtain a classification model; wherein the preset classification parameter makes the classification result of the different types of mutually assembled components consistent

14. The non-transitory storage medium according to claim 13, further comprising:
loading production data of a machine that produces the components to be assembled, to obtain dimensional data of the components to be assembled according to the production data;
obtaining size data of the components to be assembled by measuring the size of the components to be assembled.

15. The non-transitory storage medium according to claim 14, further comprising:
obtaining standard components size corresponding to each cluster component;
setting labels according to the size data of the components in each cluster and the corresponding standard component size.
